(19) United States
(12) Patent Application Publication
(10) Pub. No.: US 2014/0357244 A1
(43) Pub. Date: Dec. 4, 2014

(54) COMPARATIVE PHRASE ENGINE FOR WEATHER AND CLIMATOLOGY

(71) Applicant: The Weather Channel, LLC, Atlanta, GA (US)

(72) Inventors: Monica Roseann Schnurr, Marietta, GA (US); John Bryan Clark, Powder Springs, GA (US); Randy Mark Fussell, Marietta, GA (US); Eric Christopher Dolive, Marietta, GA (US); Karthikeyanataraj Sengottuvelappan, Johns Creek, GA (US); Neil Patrick McGillis, Marietta, GA (US); Robyn Lynn Weeks, Kennesaw, GA (US)

(73) Assignee: The Weather Channel, LLC, Atlanta, GA (US)

(21) Appl. No.: 14/288,513

(22) Filed: May 28, 2014

Related U.S. Application Data
(60) Provisional application No. 61/828,160, filed on May 28, 2013.

(51) Int. Cl. H04W 4/02

(52) U.S. Cl. CPC H04W 4/02
USPC 455/414.3

(57) ABSTRACT

Systems and methods for providing a comparative weather phrase engine that takes two (or more) locations, compares information or conditions associated with the locations, and generates a narrative phrase information the user how one location differs from another location. The information or conditions may be weather conditions, traffic conditions, tourist information or event information. The narrative phrase may be presented together with other information or advertising.

### CROSS-REFERENCE TO RELATED APPLICATION

The present application claims priority to U.S. Provisional Patent Application No. 61/828,160, filed May 28, 2013, entitled “Comparative Phrase Engine for Weather and Climatology,” which is incorporated herein by reference in its entirety.

### BACKGROUND

Users often consult resources such a websites or use mobile “apps” to research information regarding locations to which they will be traveling. For example, when a user is planning to travel to a new or unfamiliar location, and is unsure how the general weather/climate will be in this location, the user will often look at the weather forecast. While the weather forecast may provide numeric information and other raw data regarding the weather, the weather forecast does not compare the weather in the new location with the weather in a location where, e.g., the user lives, is located or has a familiarity. As such, users do not always know how “different” the weather will be in the new location.

### SUMMARY

Systems and methods for providing a comparative weather phrase engine for providing a comparative weather phrase engine that takes two (or more) locations, compares information associated with the locations, (e.g., average high temperatures, average low temperatures, and average precipitation) and generates a narrative phrase information the user how one location differs from another location. The comparative weather phrase engine may also compare weather at a location at different timescales.

In accordance with an aspect of the present disclosure, a method for generating a comparative phrase by a service provider having a web services interface including at least one server is described. The method may include providing information regarding first location; receiving an indication to compare a second location to the first location; receiving an identification of the second location; generating a phrase indicative of a comparison of the first location to the second location, the phrase being generated in accordance with rules associated with first conditions at the first location and second conditions at the second location; and providing information regarding the second location and the phrase.

In accordance with other aspects of the present disclosure, a method for generating a phrase indicative of a comparison of a first location to a second location is disclosed. The method may include defining a plurality of phrase fragments; defining a set of rules for comparing conditions the first location to the second location; receiving an indication of the first location and the second location; determining first conditions at the first location and second conditions the second location; generating, from a subset of the plurality of phrase fragments, the phrase in accordance with the rules, the first conditions and the second conditions; and providing the phrase together with information associated the second location or the second conditions.

In accordance with yet other aspects of the present disclosure, a system for generating a phrase indicative of a comparison of a first location to a second location is disclosed. The system may include a web services interface having a server, a database, and a phrase engine, the phrase engine including a plurality of phrase fragments and a set of rules for comparing conditions at the first location to conditions at the second location; and an application executing on a mobile computing device. Indications of the first location and the second location may be received from the mobile computing device and the web services interface determines first conditions at the first location and second conditions the second location. The web services interface may generate the phrase from a subset of the plurality of phrase fragments, the rules, the first conditions and the second conditions. The phrase may then be presented in a graphical user interface associated with the application.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

The components in the drawings are not necessarily to scale relative to each other. Like reference numerals designate corresponding parts throughout the several views.

FIG. 1 illustrates an exemplary environment.

FIG. 2 illustrates an operational flowchart of an example process performed in accordance with the present disclosure.

FIG. 2 illustrates a mobile device in greater detail.

FIGS. 3-6 illustrate example user interfaces.

FIGS. 7 and 8 illustrate example systems for implementing aspects of implementations of the disclosure.

### DETAILED DESCRIPTION

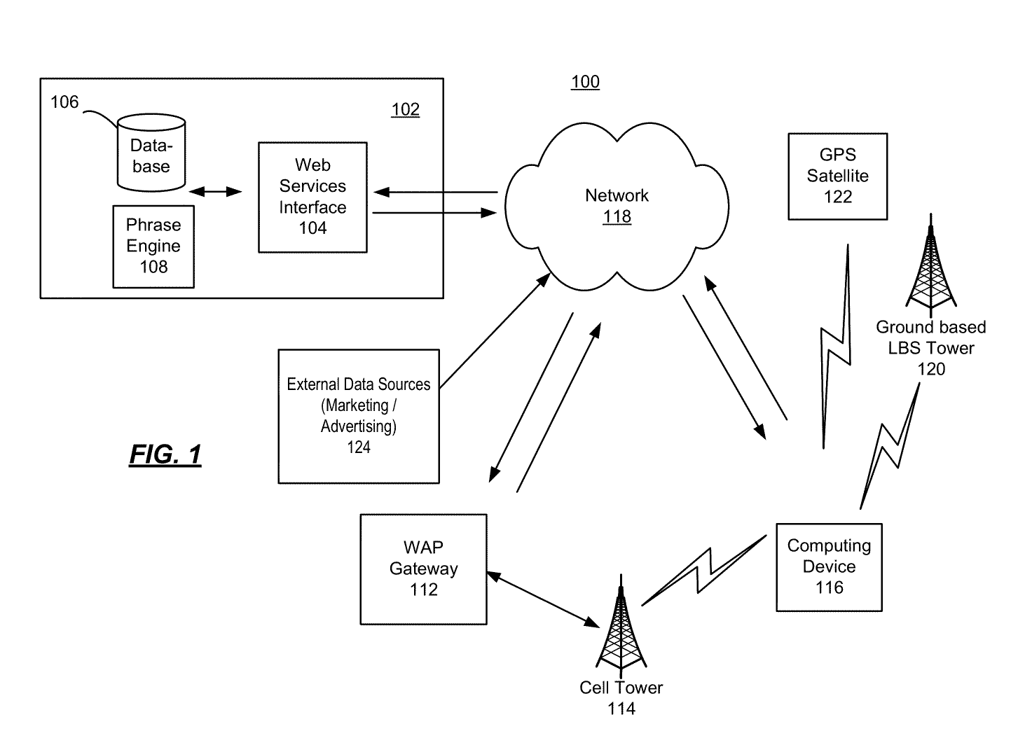

The present disclosure presents implementations for providing a comparative weather phrase engine that takes two (or more) locations, compares information associated with the locations, (e.g., average high temperatures, average low temperatures, and average precipitation) and generates a narrative phrase information the user how one location differs from another location. FIG. 1 illustrates an exemplary environment 100 for providing content to a computing device in which aspects of the present disclosure may be practiced. The environment of FIG. 1 should not be construed as limiting the present disclosure, as it is provided for exemplary purposes only.

As shown in FIG. 1, a service provider 102 may have a web services interface 104, a database 106 and a phrase engine 108. The web services interface 104 may be one or more servers that provide an interface to web services and information provided by the service provider 102. The web services interface 104 is typically placed behind one or more firewalls and a proxy gateway. The web services interface 104 provides access to back-end applications and servers on a private network of the service provider 102. The database 106 may contain weather information, phrase fragments (as described below), geographic location information, and other information about various geographic locations. The phrase engine 108 may apply a rules-based process to generate a phrase from information stored in the database 106. In particular, the phrase engine 108 may concatenate phrase fragments to generate a complete phrase that provides a comparison of conditions in a second location with those in a first location.

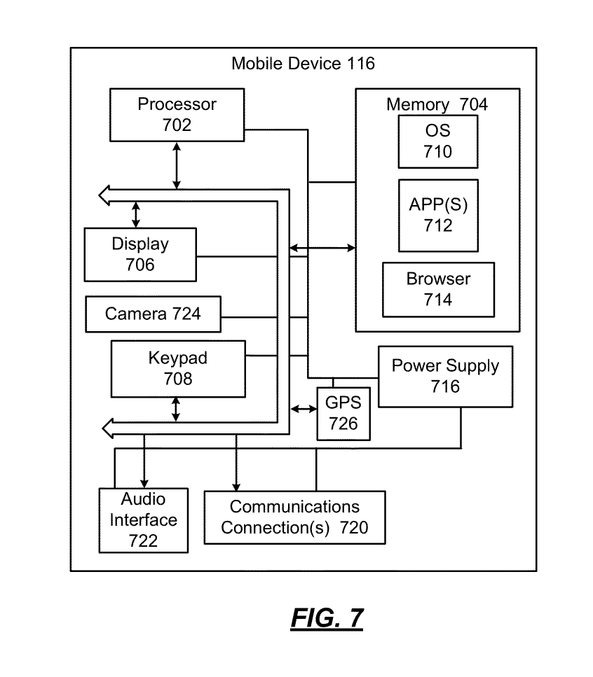

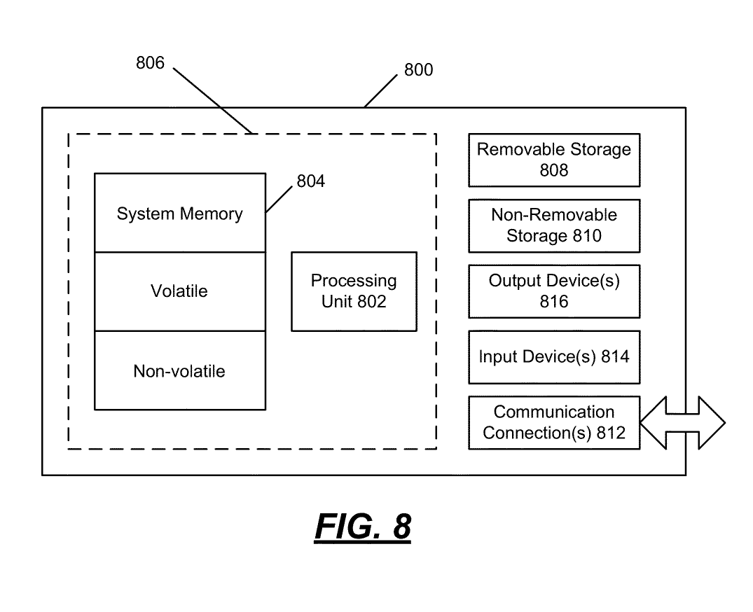

The web services interface 104 may provide a broad range of functions, such as providing content to a client device such as computing device 116. The computing device may be a mobile computing device, such as that shown in FIG. 7 or a desktop computer, a tablet device, a notebook/laptop computer), such as that described with respect to FIG. 8. The content may be any type of content, including, but not limited to web pages, audio, video and advertising. For example, as will be described below, the content may be the phrase generated by the phrase engine 108 together with at least one of a graphical component, weather information and advertising.

In some implementations, the content may be location-specific, based on determined location of the computing device 116. The location may be provided by the user, e.g., by providing a geographic location such as a city, state, country, ZIP-code. In some implementations, the location may be provided automatically, such as by a location services mechanism utilizing the global positioning system (GPS) or other location-based methodologies.

A network 118 may be any communications network, including the Internet and/or mobile networks, such as GPRS, EDGE, WCDMA, 3G, LTE. The network may include a WAP Gateway 112 that serves as proxy or a service enabler located in a service layer, between the Internet and mobile networks. The WAP protocol runs like a tunnel from the mobile via radio communications towards the connectivity layer, the control layer and finally the service layer. The WAP gateway 112 operates as a protocol converter between WAP protocols and common HTTP/TCP used by web servers on the Internet, such as the web services interface 104. As illustrated, the gateway 112 may communicate to the computing device 116 over one or more cell towers 114 associated with the network provider (e.g., AT&T, Verizon Wireless, Sprint, T-Mobile, etc.) of the computing device 116. The service layer may include other service enablers for internet mobile applications.

External data sources 124 may be communicatively coupled the service provider 102 through the network 118. The external data sources 124 may include media that is used to populate web pages and other requests made to the web services interface 104. For example, a request by the computing device 116 for a web page may trigger additional requests to the external data sources 124 for advertising creatives (e.g., images and other rich media). The weather advertising creatives may be associated with the web page requested by the computing device 116 by a location identifier, such that the data provided by the external data sources 124 is geographical and/or temporally relevant to the request. Other items of interest may be included in the external data sources 124, such as historic sites, parks and recreation areas, sporting venues, etc. Similarly, this information may be geographically coded and communicated to computing devices 116.

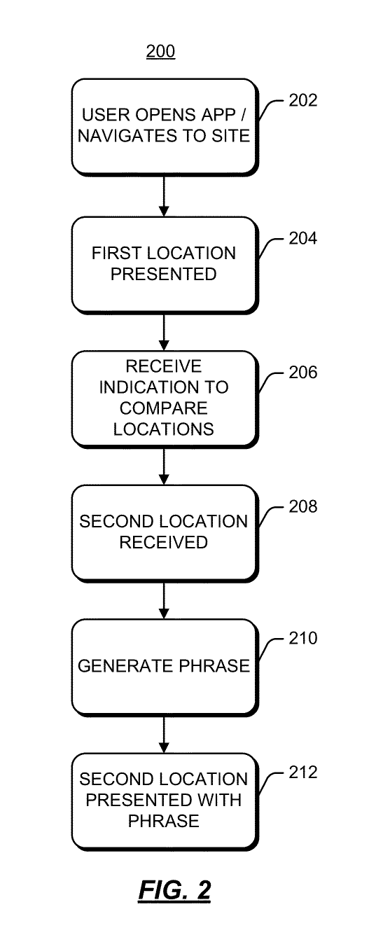

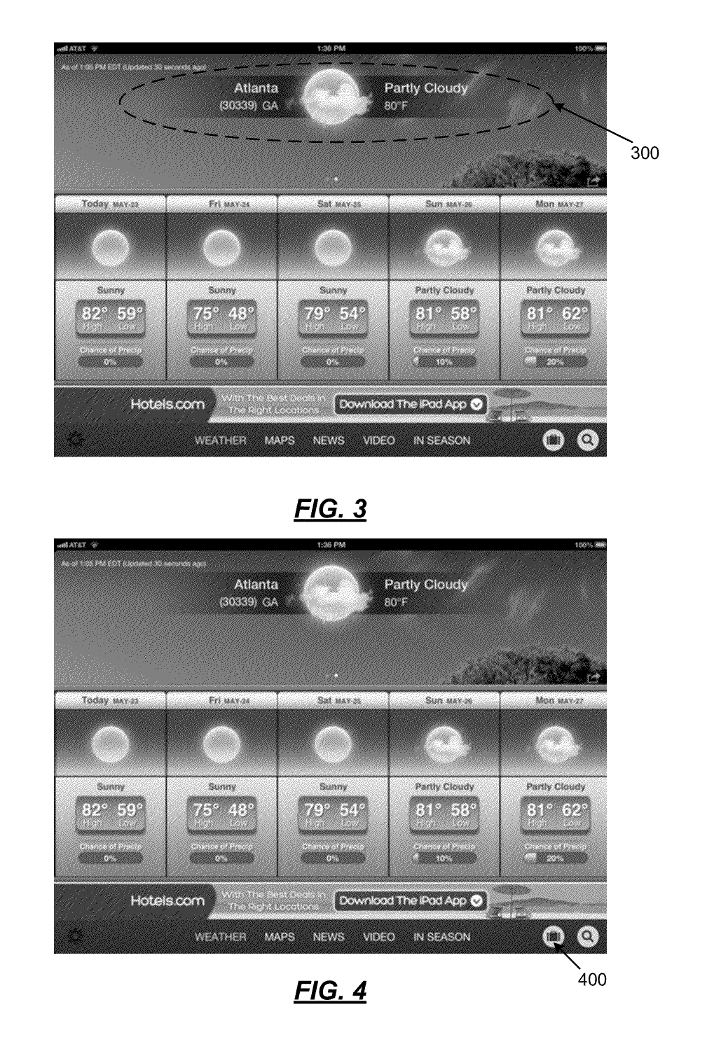

FIG. 2 illustrates an operational flowchart of an example process 200 performed in accordance with the present disclosure. At 202, a user opens an app or navigates to a website using a browser of a computing device. For example, the app may be provided by The Weather Channel of Atlanta, Ga., and made available at the iTunes App Store, Google Play or the Windows Store. The website may be www.weather.com, also provided by The Weather Channel. At 204, information regarding a first location is presented. An example user interface containing information about the first location 300 is shown in FIG. 3. The first location may be provided by the user, e.g., by providing a geographic location such as a city, state, country, or ZIP code. The first location may also be provided automatically, such as by a location services mechanism utilizing global positioning system (GPS) or other location methodologies. As shown in FIG. 3, the first location may be Atlanta, Ga. and information such as the current weather conditions may be displayed.

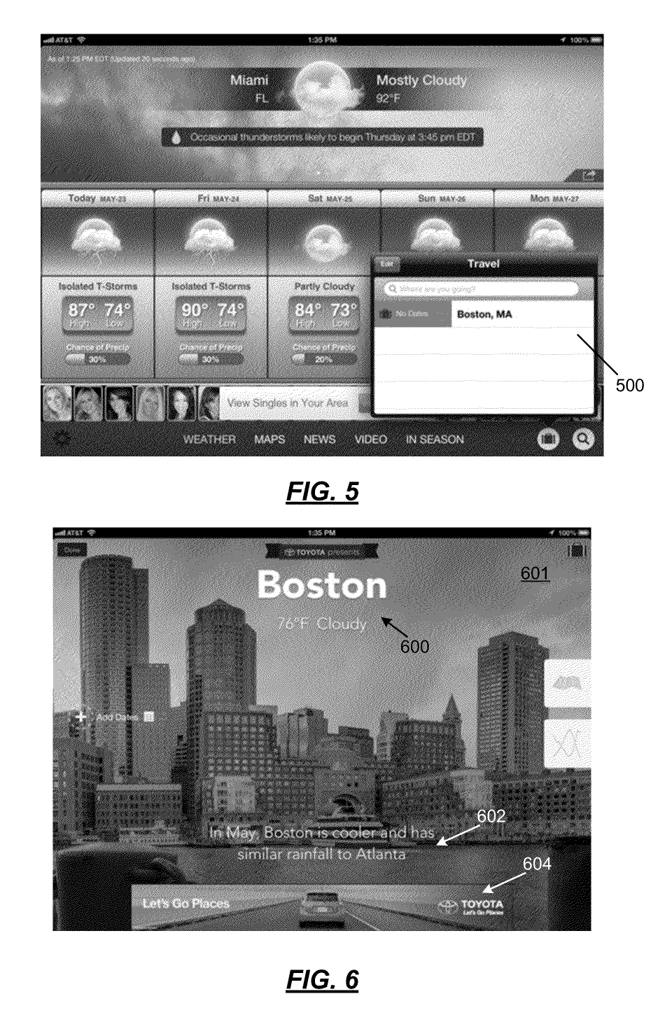

At 206, an indication is received to compare locations. For example, as illustrated in the user interface of FIG. 4, user may select a button 400 (e.g., a travel button), which then causes a dialog box 500 to be presented, as shown in FIG. 5. At 208, the second location is received. As shown in FIG. 5, the second location (e.g., Boston, Mass.) may be received within the dialog box 500. In accordance with some implementations, the second location may be saved to a “favorites” list for later recall.

At 210, a phrase is generated that compares the second location with the first location. As discussed above, the phrase engine 108 may generate a phrase that is a comparison of the general weather conditions at the second location with the first location, where the first location is generally known or familiar to the user. Table 1, below, describes a set of rules that may be applied to compare location 1 (e.g., location that the user is in or familiar with) with location 2 (e.g., the location to be compared with location 1). For example, location 2 maybe a travel destination.

In accordance with the present disclosure, the comparison phrase is generated from one or more phrase fragments that are concatenated based on comparison of the monthly average high/low temperature (T), a precipitation amount (P) and a snowfall amount (S) between location 1 and location 2. It is noted that any data other than, or in addition to, the monthly high/low temperatures, the precipitation amount, and the snowfall amount may be used to generate a phrase representative of a comparison of weather conditions between location 1 and location 2. For example, for weather conditions, relative humidity, cloud coverage conditions, UV index, etc. may be used in the comparison logic. For other comparisons, traffic information, tourist information, event information, etc., may be used in the comparison logic to compare any predetermined aspects of a second location to a first location.

TABLE 1

| Condition | phrase fragment |
|---|---|
| T = Monthly Climo High | |
| [\|T2 − T1\|] < 6F | LOC2 is about the same |
| T2 > T1 && T2 > 89F && [T2 − T1] > 19F | LOC2 is much hotter than |
| T2 > T1 && T2 > 89F && 6F <= [T2 − T1] <= 19F | LOC2 is hotter than |
| T2 > T1 && 50 <= T2 <= 89F && [T2 − T1] > 19F | LOC2 is much warmer than |
| T2 > T1 && 50 <= T2 <= 89F && 6F <= [T2 − T1] <= 19F | LOC2 is warmer than |
| T2 > T1 && T2 < 50F && [T2 − T1] >= 6F | LOC2 is not as cold as |
| T2 < T1 && T2 < 50F && [T1 − T2] > 19F | LOC2 is much colder than |
| T2 < T1 && T2 < 50F && 6F <= [T1 − T2] <= 19F | LOC2 is colder than |
| T2 < T1 && 50 <= T2 <= 89F && [T1 − T2] > 19F | LOC2 is much cooler than |
| T2 < T1 && 50 <= T2 <= 89F && 6F <= [T1 − T2] <= 19F | LOC2 is cooler than |
| T2 < T1 && T2 > 89F && [T1 − T2] >= 6F | LOC2 is not as hot as |
| P = precipitation climo; S = snowfall climo | |
| for following, set any P value that is less than the “minimum | |
| comparison threshold” to the “minimum comparison threshold”. | |
| Set this minimum comparison threshold to 0.5 to start, and make | |
| it easily configurable. | |
| P2 > P1 && [P2 − P1]/P1 < 1 && [S1 < 2 \|\| S2 < 2] | LOC2 has similar rainfall to |
| P2 > P1 && 1 <= [P2 − P1]/P1 < 2 && [S1 < 2 \|\| S2 < 2] | LOC2 has a bit more rainfall than |
| P2 > P1 && 2 <= [P2 − P1]/P1 < 3 && [S1 < 2 \|\| S2 < 2] | LOC2 has more rainfall than |
| P2 > P1 && [P2 − P1]/P1 >= 3 && [S1 < 2 \|\| S2 < 2] | LOC2 has a lot more rainfall than |
| P2 < P1 && 1 <= [P1 − P2]/P2 < 2 && [S1 < 2 \|\| S2 < 2] | LOC2 has a bit less rainfall than |
| P2 < P1 && 2 <= [P1 − P2]/P2 < 3 && [S1 < 2 \|\| S2 < 2] | LOC2 has less rainfall than |
| P2 < P1 && [P1 − P2]/P2 >= 3 && [S1 < 2 \|\| S2 < 2] | LOC2 has a lot less rainfall than |
| P2 < P1 && [P1 − P2]/P1 < 1 && [S1 < 2 \|\| S2 < 2] | LOC2 has similar rainfall to |
| S2 > S1 && S1 >= 2 && S2 >= 2 && [S2 − S1]/S1 < 1 | LOC2 has similar snowfall to |
| S2 > S1 && S1 >= 2 && S2 >= 2 && 1 <= [S2 − S1]/S1 < 2 | LOC2 has a bit more snowfall |
| | than |
| S2 > S1 && S1 >= 2 && S2 >= 2 && 2 <= [S2 − S1]/S1 < 3 | LOC2 has more snowfall than |
| S2 > S1 && S1 >= 2 && S2 >= 2 && [S2 − S1]/S1 >= 3 | LOC2 has a lot more snowfall |
| | than |
| S2 < S1 && S1 >= 2 && S2 >= 2 && 1 <= [S1 − S2]/S2 < 2 | LOC2 has a bit less snowfall than |
| S2 < S1 && S1 >= 2 && S2 >= 2 && 2 <= [S1 − S2]/S2 < 3 | LOC2 has less snowfall than |
| S2 < S1 && S1 >= 2 && S2 >= 2 && [S1 − S2]/S2 >= 3 | LOC2 has a lot less snowfall than |
| S2 < S1 && S1 >= 2 && S2 >= 2 && [S1 − S2]/S2] < 1 | LOC2 has similar snowfall to |

At 212, the second location is presented in a graphical user interface together with the generated phrase. As shown in FIG. 6, weather conditions 600 are presented for Boston, Mass. An image 601 of the second location may be presented as a background. A generated phrase 602 is shown that compares the weather in Boston (location 2) to the weather in Atlanta (location 1). For example, the phrase, “In May, Boston is cooler and has similar rainfall to Atlanta,” may be generated. As such, a user is presented with an easy to understand explanation of the weather in Boston relative to the known location of Atlanta. As such, the user may easily understand from the phrase 602 that heavier clothes should be taken on the trip to Boston than what would normally be worn in Atlanta.

In accordance with other aspects of the present disclosure, advertising 604 may be presented that is related to, e.g., location 2. A creative 604 may be presented that is associated with an advertiser or advertising campaign that is selected based on information received or used by the process 200. For example, the advertising may be triggered by the weather at location 2 such that an advertisement for outerwear is presented if the weather in location 2 is cooler than location 1. Any business logic may be applied to present advertising 604 to a user.

In accordance with yet other aspects, a user may specify dates of travel to location 2. In accordance with the actual travel dates, the phrase 602 may be updated in accordance with forecasted weather conditions to better represent a comparison of the weather in location 1 to the weather in location 2.

In accordance with yet other aspects, the comparative weather phrase engine may compare weather at a location at different timescales. For example, after six consecutive days of cloudy, rainy weather in Atlanta, the phrase engine may note improving weather with an indication that the weather will be dryer over the weekend.

Example Computing Devices 116

The computing device 116 may be configured in many different ways. For example, the computing device 116 may be a mobile phone, a PDA, a mobile computer, and the like. FIG. 7 illustrates the computing device 116 in greater detail when configured as a mobile device. FIG. 8 illustrates the computing device 116 as a general purpose computing device. The computing device 116 may includes a processor 702, a memory 704, a display 706, and a keypad 708. The memory 704 generally includes both volatile memory (e.g., RAM) and non-volatile memory (e.g., ROM, Flash Memory, or the like). The computing device 116 includes an operating system 710, such as the iOS, Android, Blackberry, Windows Phone operating systems, or another operating system, which is resident in the memory 704 and executes on the processor 702.

The keypad 708 may be a push button numeric dialing pad (such as on a typical telephone), a multi-key keyboard (such as a conventional keyboard). The display 706 may be a liquid crystal display, or any other type of display commonly used in computing devices. The display 706 may be touch-sensitive, and may act as an input device.

One or more native application programs 712 may be loaded into the memory 704 and run on the operating system 710. The computing device 116 may also include a non-volatile storage within memory 704. The non-volatile storage may be used to store persistent information which should not be lost if computing device 116 is powered down. A web browser 714 provides an environment by which a user may access information over the network 118 by entering a Uniform Resource Locator (URL) of, e.g., the service provider 102 and/or the web services interface 104. Alternatively, the URL may be of any server accessible on the network 118 by the computing device 116.

The computing device 116 includes a power supply 716, which may be implemented as one or more batteries. The power supply 716 might further include an external power source, such as an AC adapter or a powered docking cradle that supplements or recharges the batteries. The computing device 116 may include an audio interface 722 to provide audible signals to and receive audible signals from the user. For example, the audio interface 722 may be coupled to a speaker for providing audible output and to a microphone for receiving audible input, such as to facilitate a telephone conversation.

Computing device 116 also includes communications connection(s) 720, such as a wireless interface layer, that performs the function of transmitting and receiving communications, or a wired interface, such as a USB connection between the computing device 116 and another computing device. The communications connection(s) 720 facilitates wireless connectivity between the computing device 116 and the outside world. The communication connection 720 may be configured to connect to any type of wireless network. According to one implementation, transmissions to and from the communications connection(s) 720 are conducted under control of the operating system 710.

The computing device 116 may include a camera 724 as an input device. The camera 724 may be activated through an action on the keypad 708 or touch-sensitive display 706. The camera 724 may include a multi-megapixel charge-coupled display (CCD) imaging device. Pictures or video taken by the camera may be stored in the memory 704.

The computing device 116 may include a GPS receiver 726 that receives signals from one or more GPS satellites 122. By locating several GPS satellites 122, the GPS receiver 726 may determine the distance to each satellite and use this information to deduce the location of the computing device 116. This operation is based on a mathematical principle called trilateration. If the computing device 116 does not include a GPS receiver 726, other methods of trilateration may be used by determining radio signal strengths from ground based LBS tower(s) 120 or using information from the network 118.

With reference to FIG. 8, there is illustrated another example system 800 for implementing aspects of the present disclosure. In its most basic configuration, the system 800 may be a general purpose computing device, such as a desktop, a notebook, a workstation or the like and typically includes at least one processing unit 802 and memory 804. Depending on the exact configuration and type of computing device, memory 804 may be volatile (such as random access memory (RAM)), non-volatile (such as read-only memory (ROM), flash memory, etc.), or some combination of the two. This most basic configuration is illustrated in FIG. 8 by dashed line 806.

The system 800 may have additional features/functionality. For example, the system 800 may include additional storage (removable and/or non-removable) including, but not limited to, magnetic or optical disks or tape. Such additional storage is illustrated in FIG. 8 by removable storage 808 and non-removable storage 810.

The system 800 typically includes a variety of computer readable media. Computer readable media can be any available media that can be accessed by the system 800 and includes both volatile and non-volatile media, removable and non-removable media. By way of example, and not limitation, computer readable media may comprise computer storage media and communication media.

Computer storage media includes volatile and non-volatile, removable and non-removable media implemented in any method or technology for storage of information such as computer readable instructions, data structures, program modules or other data. Memory 804, removable storage 808, and non-removable storage 810 are all examples of computer storage media. Computer storage media includes, but is not limited to, RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the system 800. Any such computer storage media may be part of the system 800.

The system 800 may also contain communications connection(s) 812 that allow the device to communicate with other devices. Communications connection(s) 812 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer readable media as used herein includes both storage media and communication media.

The system 800 may also have input device(s) 814 such as keyboard, mouse, pen, voice input device, touch input device, etc. Output device(s) 816 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described previously. Rather, the specific features and acts described previously are disclosed as example forms of implementing the claims.

What is claimed:

1. A method for generating a comparative phrase by interaction with a web services interface that includes at least one server, comprising:
providing information regarding first location;
receiving, at the web services interface, an indication to compare a second location to the first location;
receiving, at the web services interface, an identification of the second location;
generating, using a phrase engine, a phrase indicative of a comparison of the first location to the second location, the phrase being generated in accordance with rules associated with a first condition at the first location and a second condition at the second location; and
providing information regarding the second location and the phrase.

2. The method of claim 1, further comprising:
defining a plurality of phrase fragments; and
concatenating a subset of the plurality of phrase fragments to generate the phrase.

3. The method of claim 2, wherein the subset of the phrase fragments are concatenated based on comparison of at least one of a monthly average high/low temperature (T), a precipitation amount (P), a snowfall amount (S), a relative humidity, cloud coverage conditions, and a UV index between the first location and the second location.

4. The method of claim 1, wherein the information regarding the second location includes at least one of a graphical component, weather information and advertising.

5. The method of claim 4, further comprising selecting the advertising in accordance with either the first location or the second location.

6. The method of claim 4, further comprising selecting the advertising in accordance with either the first condition or the second condition.

7. The method of claim 4, further comprising selecting the advertising based on weather conditions at either the first location or the second location.

8. The method of claim 1, further comprising presenting information regarding items of interest associated with the first location or the second location.

9. The method of claim 1, further comprising presenting imagery associated with the second location together with the phrase.

10. The method of claim 1, further comprising:
determining a current location of a mobile computing device associated with a user;
communicating the current location of the mobile computing device to web services interface; and
setting the first location to the current location of the mobile computing device.

11. The method of claim 1, further comprising determining the second location from a favorites list associated with a user.

12. The method of claim 1, further comprising:
receiving an indication of a time associated with the second location; and
determining the phrase in accordance with the time.

13. The method of claim 12, further comprising utilizing forecasted weather conditions to determine the phrase in accordance with the time.

14. The method of claim 1, further comprising:
providing a client application that is installable on a mobile computing device; and
providing the information regarding the second location and the phrase to a user interface associated with the client application.

15. A method for generating a phrase indicative of a comparison of a first location to a second location, comprising:
defining a plurality of phrase fragments;
defining a set of rules for comparing conditions the first location to the second location;
receiving an indication of the first location and the second location;
determining first conditions at the first location and second conditions the second location;
generating, from a subset of the plurality of phrase fragments, the phrase in accordance with the rules, the first conditions and the second conditions; and
providing the phrase together with information associated the second location or the second conditions.

16. The method of claim 15, wherein the conditions are one of weather conditions, traffic information, tourist information, and event information.

17. The method of claim 15, wherein the information is advertising.

18. The method of claim 17, further comprising selecting the advertising based on weather conditions.

19. The method of claim 15, further comprising:
receiving an indication of a time; and
determining the second conditions at the time; and
determining the phrase in accordance with the time.

20. A system for generating a phrase indicative of a comparison of a first location to a second location, comprising:
a web services interface having a server, a database, and a phrase engine, the phrase engine including a plurality of phrase fragments and a set of rules for comparing conditions at the first location to conditions at the second location; and
an application executing on a mobile computing device,
wherein indications of the first location and the second location are received from the mobile computing device, wherein the web services interface determines first conditions at the first location and second conditions the second location, wherein the web services interface generates the phrase from a subset of the plurality of phrase fragments, the rules, the first conditions and the second conditions, and wherein the phrase is presented in a graphical user interface associated with the application.
